(19) United States
(12) Patent Application Publication
(10) Pub. No.: US 2025/0149198 A1
(43) Pub. Date: May 8, 2025

(54) CONTAINER FOR A SOLID TARGET MATERIAL AND CORRESPONDING IRRADIATION STATION FOR THE PRODUCTION OF A RADIOISOTOPE

(71) Applicant: COMECER S.P.A., Castel Bolognese (IT)

(72) Inventors: Alessandro Brunetti, Castel Bolognese (IT); Marco Testa, Castel Bolognese (IT)

(21) Appl. No.: 18/835,875

(22) PCT Filed: Feb. 20, 2023
(86) PCT No.: PCT/IB2023/051537

§ 371 Date: Aug. 5, 2024

(30) Foreign Application Priority Data
Feb. 21, 2022 (IT) 102022000003206

(51) Int. Cl. G21F 5/015; G21F 5/12; G21K 5/04; G21K 5/08; H05H 6/00

(52) U.S. Cl. CPC G21F 5/015; G21F 5/12; G21K 5/04; G21K 5/08; H05H 6/00; H05H 2242/10

(57) ABSTRACT

A container for a solid target material and a radioisotope produced by proton beam irradiation of the solid target material, the container having: a well, which is suited to support on its own bottom wall a portion of solid target material; a support body, which extends along a longitudinal axis and has a seat for housing the well in such a way that the bottom wall is arranged transversely to the longitudinal axis; and a lid, which comprises a central portion having a degrader foil for degrading the proton beam and can be fitted on the support body so that the central portion is arranged in the well to retain the portion of solid target material on the bottom wall and that the degrader foil is arranged above the portion of solid target material.

### CROSS-REFERENCE TO RELATED APPLICATIONS

This patent application claims priority from Italian Patent Application No. 102022000003206 filed on Feb. 21, 2022, the entire disclosure of which is incorporated herein by reference.

### TECHNICAL FIELD

The present invention relates to a container for containing a solid target material and a radioisotope produced by proton beam irradiation of the solid target material.

In particular, the invention finds advantageous, but not exclusive, application in the production of a radioisotope using a medium- or high-energy cyclotron, i.e., a cyclotron with an energy equal to or greater than 18 MeV, starting from a solid precursor material, also known as a solid target material, in the form of a thin layer electrodeposited on a suitable metal support, or of a foil placed on the metal support, or of a compressed powder capsule placed on the metal support, to which the following description will make explicit reference without thereby losing generality.

### BACKGROUND

To date, various types of pharmaceutical-grade radioisotopes (radiopharmaceuticals) are obtained following proton beam irradiation (proton bombardment) of a solid target material typically metallic in origin.

The process of producing a radioisotope from a solid target material basically involves the following steps: positioning a portion of solid target material on a metal support; proton beam irradiating the solid target material on the support; dissolving the irradiated solid target material to obtain a solution containing the radioisotope produced by said proton irradiation; and purifying the above solution to separate the radioisotope from the unreacted target material and impurities. The positioning of the solid target material on the metal support takes place in manners that depend on the type and shape of the solid target material used. For example, the solid target material is in the form of a thin portion electrodeposited on the support, or of a metal foil, or of a compressed powder capsule.

The above steps are carried out in processing stations thereof and therefore the support carrying the solid target material must be arranged inside a container for transport between several processing stations, for example from the electrodeposition station to the irradiation station and from the irradiation station to the dissolution station.

Systems are known for the production of a radioisotope, which comprise a positioning station, an irradiation station, a dissolution station, a purification station, and an automatic transport system for transport, between some of these stations, of the container containing the support with the solid target material still to be irradiated or already irradiated. For this reason, such a container is also known as a “shuttle”.

The irradiation station comprises a cyclotron for emitting the proton beam against the solid target material, and a fluid cooling system which is connected to the support for its cooling during proton bombardment. In addition, there are known supports suitable to be placed directly in the dissolution station and capable of withstanding the agents producing the solution with the radioisotope.

Depending on the type of radioisotope to be produced, the solid target material must be irradiated by a proton beam having a specific energy. In traditional cyclotrons with energy equal to or greater than 18 MeV, there is no way to adjust the energy of the proton beam, and the known way to decrease the energy that the proton beam delivers to the solid target material is to interpose, between the cyclotron outlet and the solid target material, a metal degrader foil, normally made of aluminium, with a thickness calibrated according to the energy required for the “activation” of the solid target material for the production of the desired radioisotope.

In order to be able to produce different types of radioisotopes, it is necessary to replace the degrader foil in the irradiation station. This operation requires the irradiation station to be disassembled, and to prevent the operators from being exposed to high levels of ionizing radiation, it is necessary to deactivate the cyclotron for several hours.

### SUMMARY

The aim of the present invention is to provide a container for a solid target material for producing different types of radioisotopes, which is free from the drawbacks described above and, at the same time, easy and inexpensive to manufacture.

In accordance with the present invention, a container for a solid target material and a radioisotope produced by proton beam irradiation of the solid target material, an irradiation station for a radioisotope production system, and a radioisotope production system are provided as defined in the attached claims.

### BRIEF DESCRIPTION OF THE DRAWINGS

The present invention will now be described with reference to the accompanying drawings, which illustrate a non-limiting embodiment thereof, wherein:

FIG. 1 shows an exploded axonometric view of the container manufactured according to the present invention;

FIG. 2 shows the container in FIG. 1 as a cross-sectional view along a plane in which the longitudinal axis of the container 1 lies;

FIGS. 3 and 4 show a detail of FIG. 2 during two different uses of the container; and

FIG. 5 schematically shows an irradiation station of a radioisotope production system using the container in FIG. 1.

### DESCRIPTION OF EMBODIMENTS

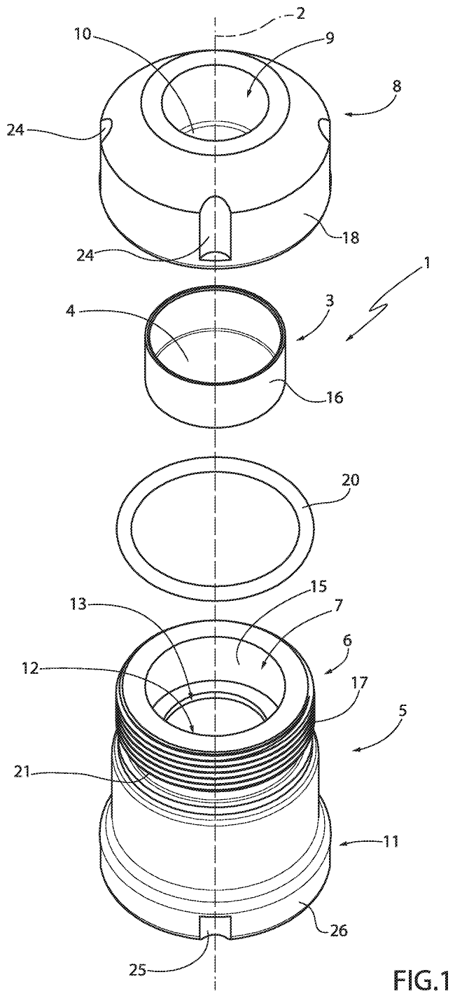

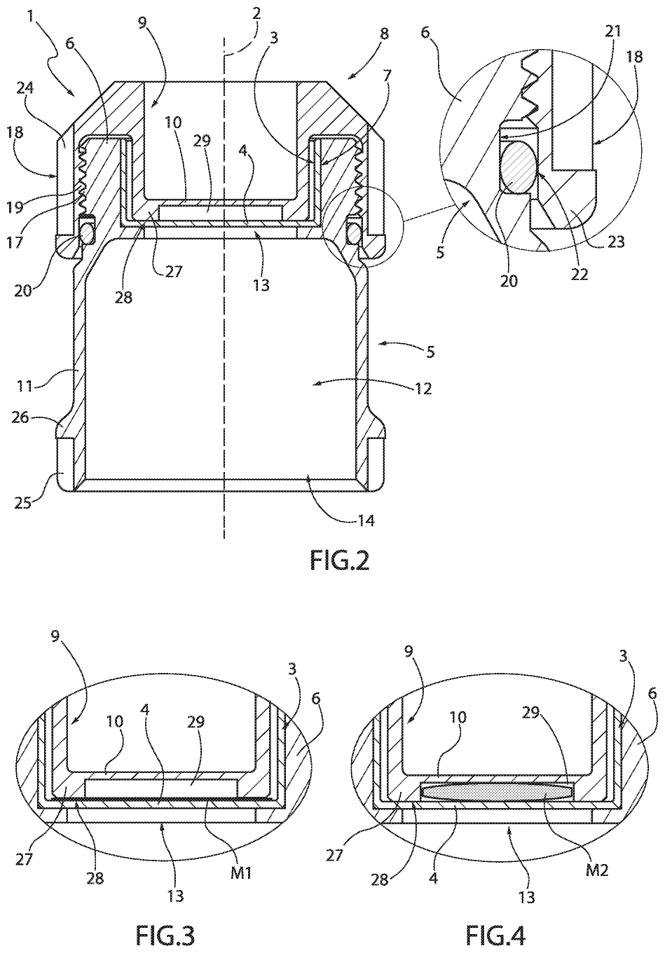

In FIGS. 1 and 2, reference numeral 1 generally designates, as a whole, the container of the present invention suitable for containing a solid target material and a radioisotope produced by proton beam irradiation of the solid target material.

The container 1 extends along its own longitudinal axis 2 and comprises a well-shaped body 3, hereinafter simply referred to as the well, which is suited to support a portion of solid target material (not shown) on its own bottom wall 4, a support body 5, which extends along the longitudinal axis 2 and comprises a first portion 6 having a seat 7 suitable, in use, to coaxially house the well 3 so that the bottom wall 4 is arranged transversely to the longitudinal axis 2, and a lid 8, which comprises a cup-shaped central portion 9, the bottom of which comprises a degrader foil 10 suitable to attenuate the proton beam in a predetermined manner. The lid 8 is suitable, in use, to be coaxially fitted on the portion 6 so that the central portion 9 is arranged in the well 3 to retain the portion of solid target material on the bottom wall 4 and that the degrader foil 10 is arranged above, and in particular parallel to, the bottom wall 4 so that the portion of solid target material is arranged, in use, between the degrader foil 10 and the bottom wall 4.

In use, a proton beam (not shown in FIGS. 1 and 2) is directed onto the central portion 9 in the direction of the longitudinal axis 2, and in particular centred on the longitudinal axis 2, to strike the degrader foil 10 substantially perpendicularly. The degrader foil 10 has a thickness calibrated to attenuate the proton beam to such an extent that an average energy (MeV) is transferred to the portion of solid target material arranged in the well 3, which allows the desired radioisotope to be obtained. For example, the thickness of the degrader foil 10 is between 50 μm and 500 μm. The thickness value is chosen according to the radioisotope to be produced. In particular, each radioisotope to be produced is associated a with corresponding lid 8 having a degrader foil 10 with a specific thickness sized according to the radioisotope.

The support body 5 has a cylindrical symmetry shape relative to the longitudinal axis 2. The well 3 has the shape of a cylindrical cup, i.e., a baseless cylinder. The lid 8 also has a cylindrical symmetry shape.

The support body 5 comprises a second portion 11, which is coaxial with the portion 6. The portion 11 comprises an inner cavity 12, which communicates with the seat 7 through a first opening 13 coaxial with the longitudinal axis 2 and with the outside through a second opening 14 (FIG. 2) transverse to the longitudinal axis 2 to allow a cooling fluid to access the cavity 12. As can be seen in FIG. 2, the bottom wall 4 of the well 3 closes the opening 13 when the well 3 is in the seat 7 so that the bottom wall 4, in use, is lapped by the cooling fluid. The cavity 12 has a cylindrical symmetry shape relative to the longitudinal axis 2.

The seat 7 houses the well 3 with hermetic interference between a lateral inner surface 15 (FIG. 1) of the seat 7 and a lateral outer surface 16 (FIG. 1) of the well 3. Such a hermetic interference is achieved by precision machining the lateral inner surface 15 and the lateral outer surface 16. The lateral hermetic interference between the seat 7 and the well 3 prevents, in use, the cooling fluid from passing through the opening 13 and ending up in the well 3.

The portion 6 of the support body 5 comprises an external thread 17, and the lid 8 comprises an annular portion 18, which is arranged around, coaxially, the central portion 9 and comprises an internal thread 19 (FIG. 2) for screwing into the portion 6.

The container 1 further comprises a hermetic sealing ring 20, which is fitted on the support body 5. In particular, the hermetic sealing ring 20 is retained in a groove 21 of the support body 5 arranged between the portion 6 and the portion 11. With particular reference to the enlarged detail in FIG. 2, the hermetic sealing ring 20 contacts the support body 5, and in particular the groove 21, and an inner surface 22 of an end portion 23 of the annular portion 18 of the lid 8 when the annular portion 18 is screwed into the portion 6. In this way, the lid 8 seals the well 3 hermetically to prevent radioactive substances from escaping from said well 3 during the production of the radioisotope.

The lid 8 comprises a plurality of external notches 24, and similarly, the portion 11 of the support body 5 comprises a plurality of external notches 25 to facilitate the grip of the operator's fingers when closing the container 1. In particular, the notches 25 are arranged along an end portion 26 of the portion 11 surrounding the opening 14.

The support body 4 and the lid 8 are made of aluminium, which is an easy-to-machine metal. The well is made of a material suitable for electrodeposition of the solid target material and is inert to acidic substances capable of dissolving the portion of solid target material. Preferably, the well 3 is entirely made of platinum. Advantageously, all the walls of the well 3 have a thickness of less than 1 mm, particularly around 500 μm.

With particular reference to FIG. 2, the central portion 9 comprises an annular rib 27 surrounding the degrader foil 10 and protruding from the plane of the degrader foil 10 parallel to the longitudinal axis 2 in order to end with an end surface 28, which is also annular, suitable to press against the bottom wall 4 of the well 3 when the lid 8 is fitted on the portion 6 so as to define, between the degrader foil 10 and the bottom wall 4, a chamber 29 centred on the longitudinal axis 2 for containing a portion of solid target material. The structure of the central portion 9 allows the solid target material to be contained in various formats.

FIG. 3 shows, in greater detail, a portion of the container 1 around the chamber 29 in an example of use in which the portion of solid target material is in the form of a metal foil, indicated with M1, which lies down on the bottom of the well 3, that is, on the bottom wall 4. In use, the lid 8 is fitted onto the portion 6 and the annular portion 18 is screwed into the portion 6 until the end surface 28 of the rib 27 presses an edge of the metal foil M1 against the bottom wall 4. The portion of metal foil M1 facing the chamber 29 will be the one irradiated by the proton beam passing through the degrader foil 10.

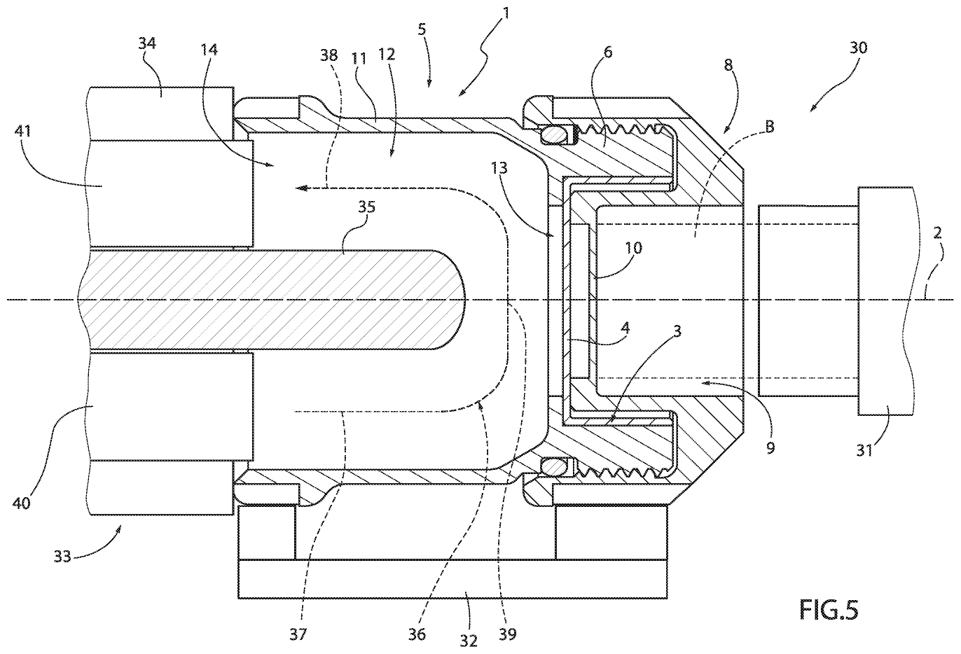

FIG. 4 illustrates the same portion of the container 1 in FIG. 3 in a different example of use in which the portion of solid target material is in the form of a compressed powder capsule, indicated with M2, which is housed in the chamber 29. In use, the lid 8 is fitted onto the portion 6 and the annular portion 18 is screwed into the portion 6 until the end surface 28 of the rib 27 contacts the bottom wall 4. In this way, the compressed powder capsule M2 is retained in the chamber 29 and centred on the longitudinal axis 2. The compressed powder capsule M2 will then be completely irradiated by the proton beam through the degrader foil 10.

In a further example of use, not shown, the portion of solid target material is in the form of a thin layer of material electrodeposited on the bottom wall 4 of the well 3 so that it remains inside the chamber 29, that is, completely below the degrader foil 10 so that it can be irradiated by the proton beam that strikes the degrader foil 10.

FIG. 5 shows in a schematic and simplified way an irradiation station 30 of a radioisotope production system which comprises the container 1. The radioisotope production system is generally known per se, and therefore not illustrated in detail. The container 1 is used in the radioisotope production system to transfer the portion of solid target material between several stations in the system, including the irradiation station 30.

The irradiation station 30 comprises a cyclotron 31 of a type known to emit the proton beam B against the portion of solid target material M arranged in the container 1. In particular, the cyclotron 31 is of the type capable of emitting a proton beam with an energy equal to or greater than 18 MeV. The irradiation station 30 comprises support means 32 of a type known to hold the container 1 in position, with the central portion 9 of the lid 8 facing the cyclotron 31 so that the proton beam B is directed onto the degrader foil 10 parallel to the longitudinal axis 2, and in particular centred on the degrader foil 10. The proton beam B passes through the degrader foil 10, which provides a predetermined attenuation, and irradiates the portion of solid target material that is in the well 3 laid on the bottom wall 4.

The irradiation station 30 comprises a fluid cooling system 33 connected to the container 1 to cool the latter during irradiation of the solid target material. In particular, the fluid cooling system 33 comprises a connection unit 34 that can be connected to the opening 14 of the support body 5 to introduce a cooling fluid into the cavity 12.

The container 1 is shown in FIG. 5 with the same sectional view as in FIG. 2. The connection unit 34 comprises a fluid diverter 35, which is designed to enter the cavity 12 through the opening 14, in the direction of the longitudinal axis 2, and is shaped to define, in the cavity 12, a circulation path 36 for the cooling fluid.

The circulation path 36 is U-shaped. In particular, the circulation path 36 comprises an inlet section 37 and an outlet section 38 for the cooling fluid, which are parallel to the longitudinal axis 2. At the opening 13, and in particular parallel to the opening 13, the circulation path 36 comprises an intermediate section 39 transverse to the longitudinal axis 2 so that, in use, the cooling fluid assumes a laminar flow along the intermediate section 39. The laminar flow will lap the surface of the bottom wall 4 of the well 3 facing the opening 13.

The connection unit 34 comprises a supply duct 40 communicating with the inlet section 37 and a return duct 41 communicating with the outlet section 38.

The main advantage of the container 1 described above is that it simplifies the operation of the irradiation station 30, which includes a cyclotron 31 of the traditional type without the possibility of adjusting the energy of the proton beam B, when one wishes to produce different types of radioisotopes, thanks to the lid 8 which incorporates a degrader foil 10. In fact, for each specific radioisotope to be produced, it is sufficient to use a corresponding lid 8 whose degrader foil 10 has a thickness calibrated for that radioisotope. In other words, the radioisotope production system comprising a traditional cyclotron 31 will have to comprise a plurality of lids 8 for the container 1, each of the lids 8 being associated with a respective type of radioisotope of a plurality of radioisotopes one wishes to produce; in this way, it will no longer be necessary to disassemble and reconfigure the irradiation station 34 each time the radioisotope to be produced changes.

Another advantage of the container 1 is that it contains the solid target material in a chamber 29 which is defined in the well 3 and is hermetically sealed, due to the special arrangement of the hermetic sealing ring 20, but which, at the same time, can be penetrated by the proton beam through the degrader foil 10. This prevents irradiation generated by the solid target material or radioactive gases and/or particles produced by the solid target material after proton irradiation from escaping from the container 1 before or during the production of the radioisotope.

Another advantage is better cooling of the well 3 and therefore of the portion of solid target material during the irradiation of the latter, thanks to the opening 13 of the inner cavity 12 of the support body 5 which puts the bottom wall 4 of the well 3 directly in contact with the cooling fluid which, in use, circulates in the cavity 12. In particular, the fluid diverter 35 entering the cavity 12 to define therein a U-shaped circulation path 36 allows the cooling fluid to assume, at the opening 13, a laminar flow that laps the bottom wall 4, thus improving the cooling of the portion of solid target material.

The aforementioned advantages are not detrimental to the practicality of use of the container 1 during the dissolution step of the radioisotope production process, thanks to the material of which the well 3 is made.

1. A container for a solid target material and a radioisotope produced by proton beam irradiation of the solid target material, the container (1) extending along a longitudinal axis (2) and comprising: a well (3), which is suited to support on its own bottom wall (4) a portion of solid target material (M1; M2); a support body (5), which extends along the longitudinal axis (2) and comprises a first portion (6) presenting a seat (7) for coaxially housing the well (3) in such a way that the bottom wall (4) is arranged transversely to the longitudinal axis (2); and a lid (8), which comprises a cup-shaped central portion (9) whose bottom comprises a degrader foil (10) and is suitable for being coaxially fitted on the first portion (6) so that the central portion (9) is arranged in the well (3) to retain the portion of solid target material (M1; M2) on the bottom wall (4) and that the degrader foil (10) is arranged above the bottom wall (4) so that the portion of solid target material (M1; M2) is arranged, in use, between the degrader foil (10) and the bottom wall (4); the degrader foil (10) having a thickness calibrated to attenuate the proton beam to such an extent to obtain the radioisotope from the portion of solid target material (M1; M2) placed in the well (3).

2. The container according to claim 1, wherein the portion of solid target material is in the form of a metal foil (M1) and the central portion (9) comprises a surface portion (28) suitable for pressing the metal foil (M1) against the bottom wall (4) of the well (3) when the lid (8) is fitted on said first portion (6).

3. The container according to claim 1, wherein the portion of solid target material is in the form of a compressed powder capsule (M2) and the central portion (9) comprises a rib (27), which surrounds the degrader foil (10) and protrudes parallel to the longitudinal axis (2) in order to end with a surface portion (28) suitable to come into contact with the bottom wall (4) of the well (3) when the lid (8) is fitted on said first portion (6) to define between the degrader foil (10) and the bottom wall (4) a chamber (29) such as to contain, in a position centered on the longitudinal axis (2), the compressed powder capsule (M2).

4. The container according to claim 1, wherein said well (3) is made of a material suitable for electrodeposition of the solid target material and is inert to acidic substances capable of dissolving the portion of solid target material (M1; M2); preferably said material is platinum.

5. The container according to claim 1, wherein said support body (5) comprises a second portion (11), which is coaxial with said first portion (6) and comprises an inner cavity (12) communicating with said seat (7) through a first opening (13) coaxial with the longitudinal axis (2) and with the outside through a second opening (14) transverse to the longitudinal axis (2) to allow access of a cooling fluid into the cavity (12); the bottom wall (4) closing the first opening (13) when the well (3) is in the seat (7) so that the bottom wall (4), in use, is lapped by the cooling fluid.

6. The container according to claim 1, wherein said seat (7) houses said well (3) with hermetic interference between a lateral inner surface (15) of the seat (7) a lateral outer surface (16) of the well (3).

7. The container according to claim 1, wherein said first portion (6) comprises an external thread (17) and said lid (8) comprises an annular portion (18), which is arranged around, coaxially, the central portion (9) and comprises an internal thread (19) for screwing into said first portion (6).

8. The container according to claim 7, and comprising a hermetic sealing ring (20), which is fitted on the support body (5) so as to contact an end portion (23) of said annular portion (18) when the latter is screwed into the first portion (6).

9. An irradiation station for a radioisotope production system, the irradiation station (30) comprising a cyclotron (31) for emitting a proton beam (B) against a portion of solid target material (M1; M2) contained in a container (1) according to claim 5, and a fluid cooling system (33) for cooling the container (1) during irradiation of the portion of solid target material (M1; M2); the fluid cooling system (33) comprising a fluid diverter (35), which is designed to enter said cavity (12) through said second opening (14) and is shaped to define in the cavity (12) a circulation path (36) for the cooling fluid; the circulation path (36) comprising, at said first opening (13), an intermediate section (39) transverse to the longitudinal axis (2) of the container (1), so that, in use, the cooling fluid assumes a laminar flow along the intermediate section (39).

10. A radioisotope production system comprising a container (1) for containing a portion of solid target material (M1; M2) and an irradiation station (30) for emitting a proton beam (B) against the portion of solid target material (M1; M2) in the container (1) so as to obtain a radioisotope; the container (1) being according to claim 5 and the irradiation station (30) comprising a cyclotron (31) for emitting a proton beam (B) against a portion of solid target material (M1; M2) contained in the container (1), and a fluid cooling system (33) for cooling the container (1) during irradiation of the portion of solid target material (M1; M2); the fluid cooling system (33) comprising a fluid diverter (35), which is designed to enter said cavity (12) through said second opening (14) and is shaped to define in the cavity (12) a circulation path (36) for the cooling fluid; the circulation path (36) comprising, at said first opening (13), an intermediate section (39) transverse to the longitudinal axis (2) of the container (1), so that, in use, the cooling fluid assumes a laminar flow along the intermediate section (39).
